(19) United States
(12) Patent Application Publication
(10) Pub. No.: US 2013/0149032 A1
(43) Pub. Date: Jun. 13, 2013

(54) FIXING MEMBER FOR VEHICLE FRAME JOINT OF SCOOTER

(71) Applicant: CHEN-CHI HSIAO, CHIA YI CITY (TW)

(72) Inventor: CHEN-CHI HSIAO, CHIA YI CITY (TW)

(73) Assignee: SUNPEX TECHNOLOGY CO., LTD., CHIA YI CITY (TW)

(21) Appl. No.: 13/315,360

(22) Filed: Dec. 9, 2011

(51) Int. Cl. F16D 1/00

(52) U.S. Cl. 403/408.1

(57) ABSTRACT

A fixing member for a vehicle frame joint of scooters is revealed. Both a front frame and a rear frame are disposed with insertion holes correspondingly. A main rod with a pivot is disposed on the front or the rear frame. A fixing unit is arranged between the front and the rear frames. A rotatable disk of the fixing unit is connected pivotally to the pivot of the main rod. One end of a pull handle is disposed on one side of the rotatable disk while the other end is connected to an insertion pin that inserts through the insertion holes of the front and rear frames. Thereby the pull handle and the insertion pin are inserted into or released from the insertion holes of the front and the rear frames by rotating the rotatable disk of the fixing unit so as to connect and disconnect the frames.

### BACKGROUND OF THE INVENTION

1. Field of the Invention

The present invention relates to a fixing member for a vehicle frame joint of a scooter, especially to a fixing member for a vehicle frame joint of a folding scooter that makes joining of vehicle frames of a folding scooter easier and more stable.

2. Description of Related Art

Some people have problems with mobility while walking or standing due to car accidents, diseases (such as stroke) injuries to legs, or poor physical health. When these people intend to move, they need mobility aids such as canes, wheelchairs, scooters, etc. Although scooters available on the market now help people with restricted mobility to move around with ease, they are designed in an integrated piece, unable to be folded. While not in use, the scooter takes quite a lot space. Moreover, this causes inconvenience in storage and transportation.

Thus a folding scooter in which a vehicle frame and a seat are foldable is invented. Refer to Taiwanese Pat. No. M374858 “vehicle frame and seat of scooter”, a main rod and a sleeve sleeved with each other are disposed between a front frame and a rear frame. A seat is connected to the rear frame by a support rod. By the sleeve and the main rod between the front and rear frames, the front frame and the rear frame are folded smoothly. The support rod lifts, lowers and folds the seat by a first link rod and a second link rod staggered with and pivoted to each other. Thereby both the vehicle frame and seat are arranged with folding members so that the volume of the scooter is reduced effectively for easy storage and convenient transportation.

However, for connecting the front frame and the rear frame revealed in the Taiwanese Pat. No. M374858, the main rod of the front frame needs to be aligned with the sleeve of the rear frame precisely. Moreover, guiding rods on two sides of the front frame are also corresponding to guiding slots on two sides of the rear frame properly. Thus the front frame and the rear frame are joined together and connected to each other. The joining and assembling require higher precision. After joining the vehicle frames, users need to mount a threaded insertion pin into the sleeve of the rear frame and the main rod of the front frame with great effort so as to fix the joining between the front frame and the rear frame. For users with physical disabilities, or the elders with poor physical health, this causes inconvenience in assembling. Furthermore, the threaded insertion pin may get loose easily due to vibrations while the scooter moving over a rough road. The frames of the scooter may be disassembled during the driving process and jeopardize the user's safety.

Thus the structure of the scooter revealed in the Taiwanese Pat. No. M374858 is not convenient for users with physical disabilities or poor physical health to assembly and use. Moreover, the fixing member may get loose and cause the frames of the scooter to separate. There is room for improvement and a need to provide a novel fixing member for a vehicle frame joint of the scooter.

### SUMMARY OF THE INVENTION

Therefore it is a primary object of the present invention to provide a fixing member for a vehicle frame joint of a scooter by which frames of the scooter are assembled and disassembled easily and the joint between the frames is stable.

In order to achieve the above object, a fixing member for a vehicle frame joint of scooter of the present invention includes a front frame and a rear frame, both having insertion holes correspondingly. A main rod with a pivot is disposed on the front frame or the rear frame. A fixing unit is arranged between the front frame and the rear frame. The fixing unit includes a rotatable disk connected pivotally to the pivot of the main rod. One end of a pull handle is disposed on each of two sides of the rotatable disk while the other end thereof is assembled with an insertion pin. The insertion pin inserts through the insertion hole of the front frame and the insertion hole of the rear frame.

The fixing member further includes an elastic part set between the rotatable disk and the main rod.

In the fixing member, the rotatable rotary disk is further disposed with a handle.

Thereby the pull handle of the rotatable disk and the insertion pin connected on the end of the pull handle can be adjusted to be inserted into or released from the insertion holes of the front and the rear frames only by rotating the rotatable disk of the fixing unit. Thus the front and the rear frames are locked or released from each other. Thus the joint between the frames of the scooter is connected or disconnected easily and conveniently.

Moreover, the fixing member for a vehicle frame joint of scooters mainly consists of the rotatable disk, the pull handles, the insertion pins and an elastic part. The structure is simple so that manufacturing cost and production time are reduced. The competitiveness of the scooter on the market is dramatically improved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is a perspective view of an embodiment according to the present invention;

FIG. 3 is an assembled view of an embodiment according to the present invention;

FIG. 4 is another assembled view of an embodiment according to the present invention;

FIG. 5 is a disassembled view of an embodiment according to the present invention.

### DETAILED DESCRIPTION OF THE PREFERRED EMBODIMENT

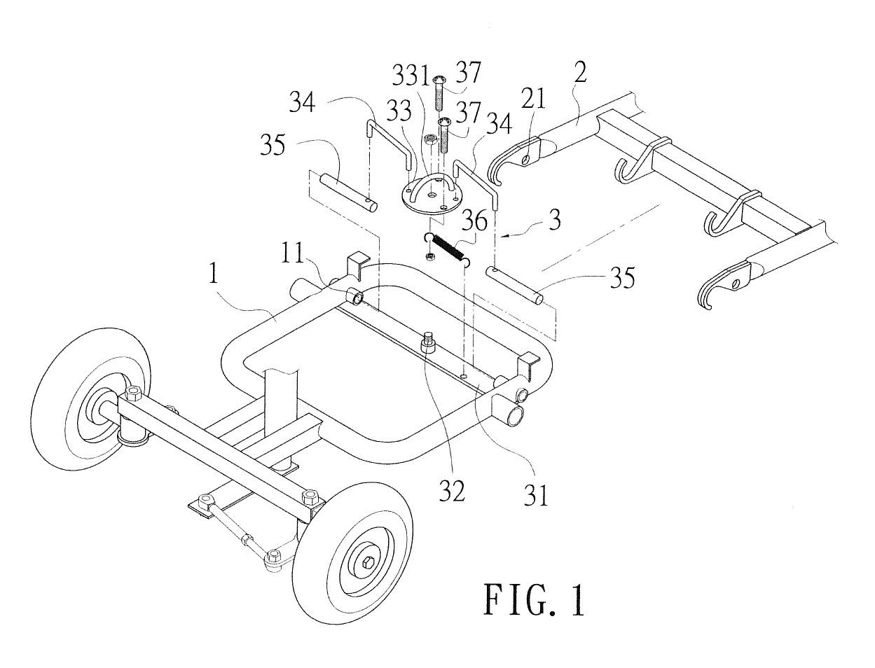

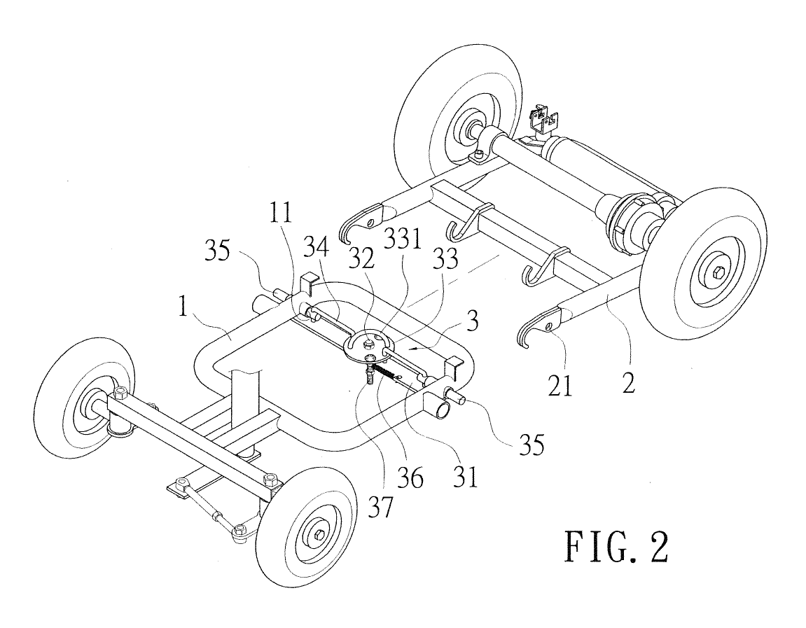

Refer to FIG. 1 and FIG. 2, a fixing member for a vehicle frame joint of scooters includes a front frame 1, a rear frame 2 jointed and assembled with the front frame 1 and a fixing unit 3 disposed between the front frame 1 and the rear frame 2.

The fixing unit 3 includes a main rod 31 disposed on the front frame 1 and a pivot 32 arranged at a middle of the main rod 31. A rotatable disk 33 set with a handle 331 is assembled with the pivot 32 of the main rod 31. One end of a pull handle 34 is pivotally connected to each of two sides of the rotatable disk 33 while the other end of the pull handle 34 is pivotally connected to an insertion pin 35. The two insertion pins 35 are inserted through an insertion hole 11 on each of two sides of the front frame 1 and an insertion hole 21 on each of two sides of the rear frame 2 to be positioned therein. Moreover, an elastic part 36 is set between the rotatable disk 33 and the main rod 31 of the front frame 1 and two limit rods 37 rods are disposed porjectingly from the bottom of the rotatable disk 33, respectively against a front edge and a rear edge of the main rod 31.

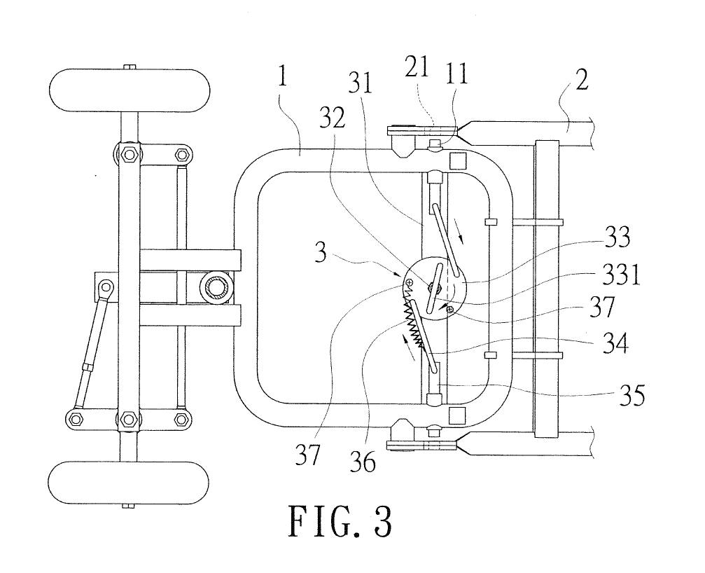

When users want to ride the scooter, refer to FIG. 3, the front frame 1 and the rear frame 2 are joined together. Then user's hand holds the handle 331 on the rotatable disk 33 of the fixing unit 3 and applies forces to rotate the rotatable disk 33 to a certain angle. At the same time, the pull handle 34 on each of two sides of the rotatable disk 33 are pulled inwards so as to make the insertion pin 35 connected to the pull handle 34 change from projecting out of the insertion hole 11 on each of two sides of the front frame 1 into being retracted into the insertion hole 11 of the front frame. Moreover, by the limit rod 37 on the bottom of the rotatable disk 33 against the rear edge of the main rod 31, the rotation angle of the rotatable disk 33, the movement of the pull handle 34 and the movement of the insertion pin 35 are restricted. Thus the insertion pin 35 will not falling out of the insertion hole 11 of the front frame 1 even being over-pulled.

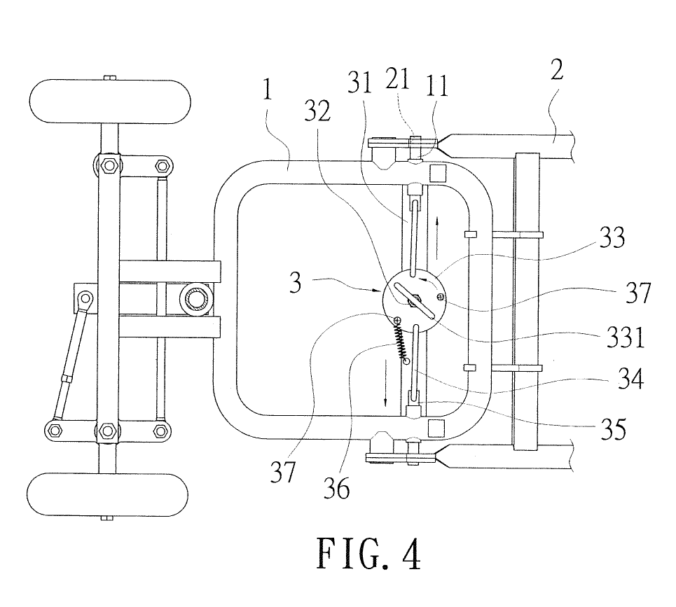

Refer to FIG. 4, release the force applied to rotate the rotatable disk 33. At this moment, the elastic part 36 being stretched by the rotatable disk 33 before goes back to the original state. The other limit rod 37 on the bottom of the rotatable disk 33 is against and positioned on a front edge of the main rod 31. Thus the rotatable disk 33 turns back to the original position. The pull handles 34 on two sides of the rotatable disk 33 also turn back to the original positions to make the insertion pins 35 insert through the insertion holes 11 of the front frame 1 and into the insertion holes 21 of the rear frame 2. The joined front and rear frames 1, 2 are secured. In accordance with the above steps, the joined front and rear frames 1, 2 are locked and fastened with each other easily to form a stable frame of the scooter. Thus users can ride the scooter.

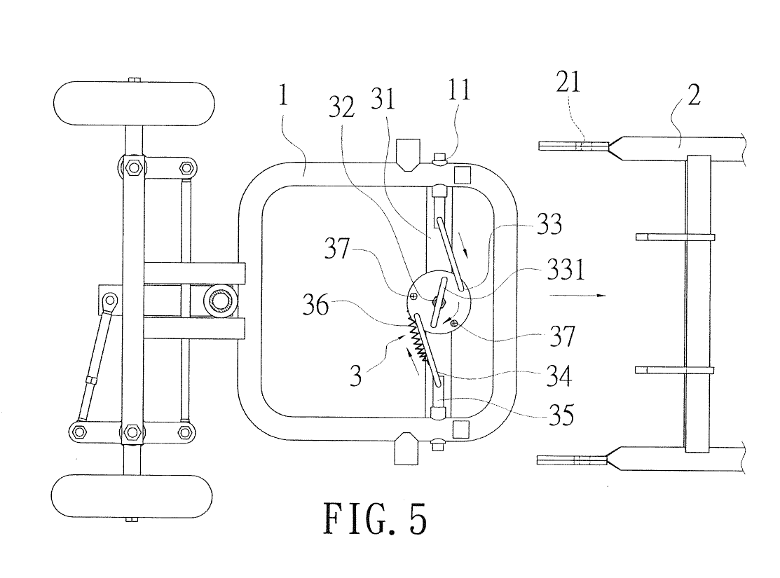

Furthermore, when users want to transport or store the scooter, they need to fold the scooter for reducing the total volume and increase convenience in transportation and storage. Refer to FIG. 5, the user applies force to the rotatable disk 33 to rotate the rotatable disk 33 and pull the pull handle 34 on two sides of the rotatable disk 33 inward. Each insertion pin 35 is released from each insertion hole 21 on two sides of the rear frame 2. The locked front and the rear frames 1, 2 are released and the front and the rear frames 1, 2 are not joined with each other. Next fold the front and the rear frames 1, 2 and the volume of the scooter is dramatically reduced for easy transportation and convenient storage.

According to the above locking and releasing processes, it is learned that the scooter of the present invention has simple structure so that the manufacturing cost and production time are reduced significantly. Moreover, the lock way and the release way are simple and convenient. Thus for users with physical disabilities or elders with poor physical health, they can assemble and disassemble the scooter frames easily and conveniently by themselves. The folding scooter is more convenient to use.

The main rod 31 and the pivot 32 thereof can also be arranged at the rear frame 2. Thus the rest components of the present invention such as the rotatable disk 33, the pull handle 34, and the insertion pin 35 are also on the rear frame 2.

In summary, the present invention has following advantages:

1. While in use, users only need to rotate the rotatable disk for inserting or releasing the insertion pin connected on the end of each of two pull handles set on the rotatable disk so as to connect or disconnect the front frame and the rear frame. For users with physical disabilities or poor physical health, they can assembled and disassemble the frames of the scooter easily and effortlessly.

2. The insertion pin arranged at the end of the pull handle is driven by the rotatable disk to insert transversely into the insertion holes of the front frame and the rear frame. Thus the insertion pins will not get loose easily under the influence of vibration while the scooter moving over a rough road. The scooter frames will not disconnect during the driving process due to the falling fixing unit and the users' safety is assured.

3. The fixing member for a vehicle frame joint of scooters is mainly composed of the rotatable disk, the pull handles, the insertion pins and an elastic part. The structure is simple. Thus manufacturing cost and production time are reduced and the competitiveness of the scooter on the market is dramatically improved

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A fixing member for a vehicle frame joint of scooters comprising a front frame having insertion holes, a rear frame having insertion holes corresponding to the insertion holes of the front frame, a main rod disposed on the front frame or the rear frame, a pivot arranged at the main rod, and a fixing unit set between the front frame and the rear frame; wherein the fixing unit includes a rotatable disk, at least two pull handles and at least two insertion pins; the rotatable disk is pivotally connected to the pivot of the main rod; one end of the pull handle is disposed on one side of the rotatable disk and the other end of the pull handle is connected to the insertion pin; the insertion pin passes through the insertion hole of the front frame and the insertion hole of the front frame.

2. The device as claimed in claim 1, wherein the fixing member further includes an elastic part arranged between the rotatable disk and the main rod.

3. The device as claimed in claim 2, wherein a bottom of the rotatable disk is projectingly disposed with at least one limit rod that is against the main rod.

4. The device as claimed in claim 3, wherein there are two limit rods respectively against a front edge and a rear edge of the main rod.

5. The device as claimed in claim 1, wherein a bottom of the rotatable disk is projectingly disposed with at least one limit rod that is against the main rod.

6. The device as claimed in claim 5, wherein there are two limit rods respectively against a front edge and a rear edge of the main rod.

7. The device as claimed in claim 1, wherein the rotatable disk is further arranged with a handle.
